(19) United States
(12) Patent Application Publication
(10) Pub. No.: US 2006/0041415 A1
(43) Pub. Date: Feb. 23, 2006

(54) Apparatus, system, and method for inter-device communications simulation

(76) Inventors: Richard Scott Dybas, Tucson, AZ (US); Robert Goodwin Long, Tucson, AZ (US)

Correspondence Address: KUNZLER & ASSOCIATES, 8 EAST BROADWAY, SUITE 600, SALT LAKE CITY, UT, 84111, US

(21) Appl. No.: 10/923,234

(22) Filed: Aug. 20, 2004

(51) Int. Cl. G06F 17/50

(52) U.S. Cl. 703/13

(57) ABSTRACT

An apparatus, system, and method of simulating communications between a plurality of devices are provided. A series of commands and data block sizes are recorded as trace data by a recording device and stored in a library of trace data. The system functionally includes a first device and a second device, the second device being the device under test. The first device can be replaced by an apparatus that simulates the communications of the first device with the second device. The simulator recreates the commands of the first device by accessing the prerecorded trace data. An apparatus, system and method for measuring and analyzing the performance of modifications made to the trace data are also provided.

### BACKGROUND OF THE INVENTION

1. Field of the Invention

This invention relates to inter-device communications and more particularly relates to an apparatus, system and method for simulating communications between a plurality of devices.

2. Description of the Related Art

In a product's life cycle, including design, development, test, troubleshooting and maintenance, it is often useful to have the capability to determine the product's response to real world environments. Some testing solutions have been developed in response to this problem, but these solutions are often difficult and costly to implement.

Many of the test solutions require a dedicated test environment, including all of the hardware and software involved in a real world environment. Acquiring all of the hardware and software required for this type of test environment is rarely cost effective, because the test environment is normally not utilized between tests. Additionally, depending on the type of the equipment involved, the needs of the particular product activity may not justify the magnitude of expenditures required for the test. The cost of the test environment is not the only problem with this approach.

In the case of troubleshooting and maintenance, recreating exactly the same environment as the problematic environment can be difficult. Often, not all of the equipment in the problematic environment is available for use in the test environment. If the test environment is not complete, the tests performed may be deficient in terms of useful information that can be collected. These issues can be particularly challenging to overcome when the test is required for product development.

During product development, it is often difficult to calculate the exact response to changes in design that a particular system will exhibit. It is therefore useful to be able to check the impact of design changes as the changes are being made. Unfortunately, tools currently available to make such checks are usually simply based on theory, and don't take into consideration the intricacies of individual systems. In most cases, future uses of the device and environments in which the device will be placed are unknown at the time of development. Some of the factors that may not be accurately modeled in such tools include the exact hardware configuration, including connector cable types, processor speeds, I/O port types, distance between devices, etc. Another factor that is often difficult to model is the impact of transmitting various types of data, where the differences may include compressibility, random pattern, etc.

From the foregoing discussion, it should be apparent that a need exists for an apparatus, system and method that simulate communications between a plurality of devices. Beneficially, such a process, apparatus, and system would make possible accurate simulation of real world hardware configurations, without the need for a dedicated hardware test environment.

### SUMMARY OF THE INVENTION

The various embodiments of the present invention have been developed in response to the present state of the art, and particularly, in response to the problems and needs in the art that have not yet been met for a reliable, cost-effective, and versatile testing of communications between a plurality of devices. Accordingly, the various embodiments have been developed to provide an apparatus, system, and method for simulating communications between a plurality of devices that overcomes many or all of the above-discussed shortcomings in the art.

The apparatus for simulating communications between a plurality of devices is provided with a logic unit containing a plurality of modules configured to functionally execute the necessary steps of accessing trace data representative of actual communications between a first device and a second device, generating a command from the trace data to simulate an original communication, and issuing the command to a second device. These modules in the described embodiments include a reader module, a generator module, and a controller module.

Preferably, the reader module accesses trace data representative of communications between a first device and a second device. The trace data, in one embodiment, comprises prerecorded communications between a first device and a second device. Multiple trace data records may be collocated in a library. A particular trace data set may be selected from the library according to at least one performance characteristic of the second device. The trace data set may be selected to facilitate product activities for the second device selected from a group consisting of product development, product testing, and product troubleshooting.

Preferably, the generator module generates a command from the trace data to simulate an original communication. It may be desirable to tailor the commands and associated data, to more completely simulate a particular hardware environment. In order to accomplish such tailoring, a modification module and a designation module may be included in the apparatus design. In one embodiment, the modification module is configured to modify the trace data, changing the order and type of the commands generated, and optionally the rate that the commands will be issued in order to test performance of the second device.

In an additional embodiment, the designation module is configured to designate a dummy data set for the command. The term dummy data, as used herein, may be defined as test data, fill data, random data, actual data and other terms defining a data set to be communicated between a first device and a second device. In one embodiment, the dummy data is selected to facilitate product activities selected from the group consisting of product development, product testing, and product troubleshooting. The dummy data may be selected from a library of one or more dummy data sets.

Preferably, the controller module issues the command to the second device. In one embodiment, both the command and a dummy data set are sent to the second device. In various embodiments of the apparatus, it may be necessary to collect and interpret data representative of the performance of the second device. A measurement module configured to measure performance of the second device in response to the command may be provided. In a further embodiment, the apparatus includes an analysis module configured to analyze a performance impact of modifications made to the trace data.

An alternative embodiment of the apparatus for simulating communications between a plurality of devices includes a reader module configured to access the trace data representative of communications between a first device and a second device, a generator module configured to recreate a command from a line of the trace data to simulate an original communication command, and a controller module configured to issue the command to a receive port of the device. In this embodiment, the apparatus performs substantially the same functionality as the apparatus described in embodiments above, the primary difference being the location of the apparatus with respect to the second device. In this embodiment, the apparatus comprise a module of the second device. Instead of issuing the commands to another device, the module issues the commands to the receive port of itself.

A system of the present invention is also presented for simulating communications between a plurality of devices. In one embodiment, the system includes a recorder module configured to record communications between a first device and a second device. The system also includes a library of trace data sets representative of communications between one or more first devices and a second device. Additionally, a simulator module is included, the simulator module being configured to simulate communications with the second device. The simulator module comprises a reader module, a generator module, and a controller module. The reader module is configured to access a trace data set from the library. The generator module is configured to generate a command from the trace data set, the command simulating an original communication. The controller module is configured to issue the command to the second device. In this embodiment of the system, the second device is in communication with the simulator and configured to receive and respond to the command.

The system may further include a listener that listens for responses from the second device to commands issued by the simulator module. In addition to these embodiments, the system performs substantially the same functionality as the apparatus describe above.

A method of the present invention is also presented for simulating communications between a plurality of devices. The method in the disclosed embodiments substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for recording communications between a plurality of devices;

FIG. 2 is a schematic block diagram illustrating one embodiment of a system for simulating communications between a plurality of devices;

FIG. 3 is a schematic block diagram illustrating one embodiment of an apparatus for simulating communications between a plurality of devices;

FIG. 4 is a schematic block diagram illustrating a detailed embodiment of an apparatus for simulating communications between a plurality of devices;

FIG. 5 is a schematic flow chart diagram illustrating one embodiment of a method for simulating communications between a plurality of devices;

FIG. 6 is a schematic flow chart diagram illustrating one detailed embodiment of a method for simulating communications between a plurality of devices; and

FIG. 7 is a schematic block diagram illustrating an embodiment of an environment that uses one embodiment of an apparatus for simulating communications between a plurality of devices.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

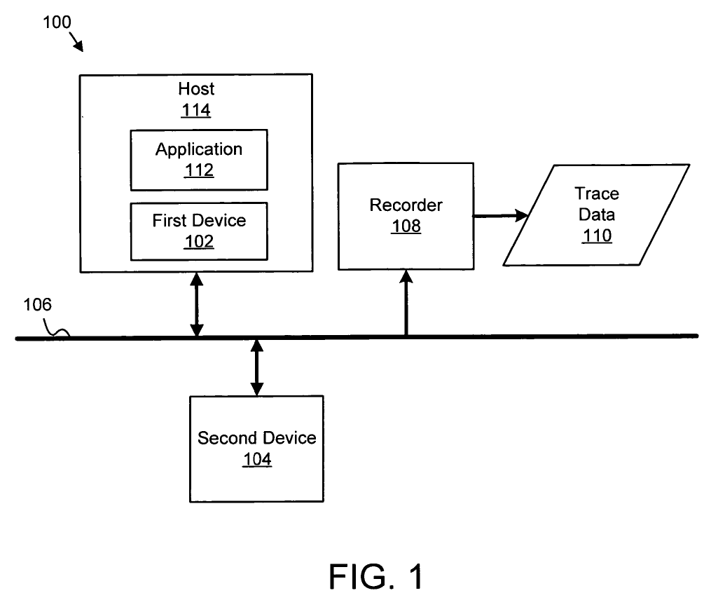

FIG. 1 illustrates a schematic block diagram of a system 100 for recording communications between a plurality of devices. The system 100 may include a host 114 comprising an application 112 and a first device 102, in communication with a second device 104 via a data connection 106. A recorder 108 records the communications between the first device 102 and the second device 104, and stores trace data 110 representative of the commands in a trace data 110 file.

In one embodiment, the host 114 is an application server hosting one or more applications 112 and a first device 102. The application 112 feeds data and commands to the first device 102, and the first device 102 issues the commands and the data to the second device 104 via the data connection 106. In one particular embodiment, the first device 102 is a data transceiver configured to communicate data with the second device 104 via a Small Computer System Interface (SCSI) protocol data connection 106. In an alternative embodiment, the first device 102 is a fiber channel transceiver configured to communicate data with the second device 104 via a fiber channel data connection 106.

The second device 104 may comprise substantially any hardware configured to communicate with the first device 102. For example, the second device may be a persistent storage device such as a disk drive, a tape drive, a storage subsystem, or the like. In an alternative embodiment, the second device 104 may be a non-persistent storage device such as a Random Access Memory (RAM) drive. In another embodiment, the second device 104 is another data processing device.

Preferably, the system 100 is set up once, and a series of tests may be performed and recorded using the recorder 108. The recorder 108 is hardware or software configured to generate trace data 110 representative of the actual commands passing between the first device 102 and the second device 104. In one embodiment, the recorder 108 is an IBM Atape™ device driver trace facility. The Atape™ trace facility records SCSI based communications. The recorder 108 may record trace data 110 in the form of human readable text files. Each line of the trace data 110 file preferably contains a record of an original command along with a time stamp and a data block size. In an alternative embodiment, another command tracing utility may serve as the recorder 108. In this embodiment, the recorder 108 may record the trace data 110 using various logical or physical formats. In one embodiment, the trace data 110 is in binary or hexadecimal format. In certain embodiments, the recorder 108 records the native communication commands such as SCSI Command Descriptor Blocks (CDBs). Alternatively, the recorder 108 records sufficient information about the inter-device communications that the actual commands can be recreated.

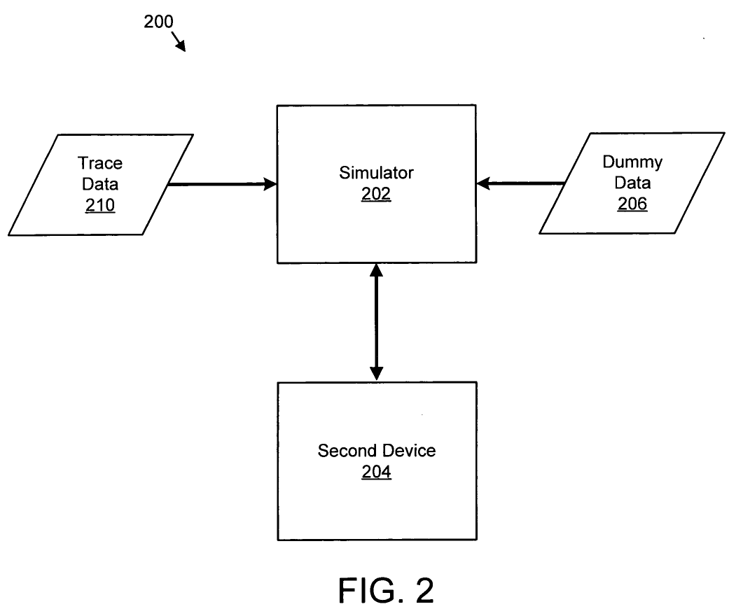

FIG. 2 illustrates a logical block diagram of a system 200 for simulating communications between a plurality of devices. In one embodiment, the system 200 includes a simulator 202 that communicates commands generated from trace data 210 and/or designated dummy data 206 with a second device 204.

In the system 200, the simulator 202 replaces the first device 102 of the system 100 and most of the physical devices required to originally record the trace data 210. The simulator 202 generates the commands originally sent by the first device 102 by reading the trace data 210 of communications originally between the first device 102 and the second device 104. The trace data 210 may be any prerecorded trace data of inter-device communications. In one embodiment, the trace data 210 is modified from its original format. Similarly, the dummy data 206 is not necessarily the data originally communicated in the system 100 for recording communications. The dummy data 106 can be embodied as a random pattern data, binary ‘1010’ data, compressed data, and other nonspecific data embodiments. Typically, the dummy data serves as filler such that timing and other data specific performance characteristics can be accurately simulated.

The simulator 202 may comprise a desktop computer configured with a SCSI based I/O port. Alternatively, the simulator 202 may be a dedicated hardware test device configured to simulate the communications. The second device 204 may be different from an original second device 104 in the system 100 for recording the communications. Alternatively, the second device 204 may be another model of tape drive. In another alternative embodiment, the second device 204 may be another type of device such as a processing device, disk drive, or the like. Consequently, various second devices 204 can be tested using the same trace data 210 and/or dummy data 106 without re-configuring a physical testing environment. Instead, various test second devices 204 are connected to the simulator 202 and tested as though a real physical test environment had been established.

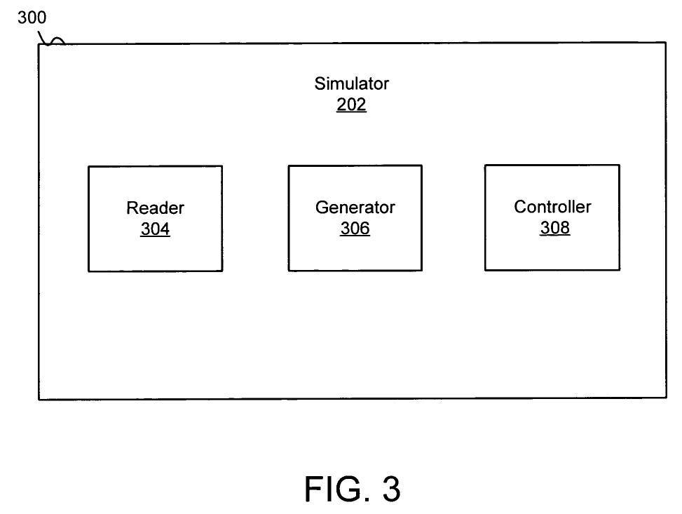

FIG. 3 illustrates a logical block diagram of an apparatus 300 for simulating communication between a plurality of devices. The apparatus 300 may comprise a reader module 304, a generator module 306, and a controller module 308. The reader module 304 accesses and reads the trace data 210, and passes the trace data 210 to the generator module 306. The generator module 306 generates a command from the trace data 210 that simulates an original command from the first device 102. The controller module 308 then issues the command to the second device 204.

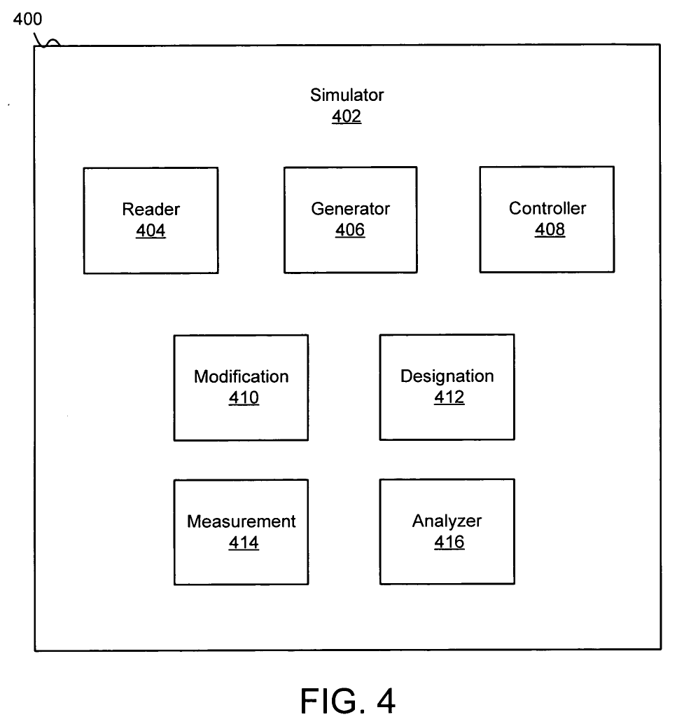

FIG. 4 illustrates a detailed logical block diagram of an apparatus 400 for simulating communications between a plurality of devices. The apparatus 400 includes a reader module 404, a generator module 406, and a controller module 408. These modules function substantially the same as respective modules 304, 306, and 308 discussed in relation to FIG. 3. Additionally, the apparatus 400 includes a modification module 410, a designation module 412, a measurement module 414, and an analysis module 416.

The modification module 410 allows the order, type, and rate at which the commands are issued from the trace data 210 to be changed to test a specific performance characteristic. For example, it may be desirable to test the maximum data transmission rate between the simulator 202 and the second device 204. To test the data transmission rate, the modification module 410 may increase the block size of the data to be transmitted with each command. Alternatively, the modification module 410 may increase the rate at which the commands are to be issued.

The designation module 412 designates a set of dummy data 206 to be issued with the command. The size of the dummy data block may be determined by the data block size in the command represented by the trace data 210. The designation module 412 may also alter the type of dummy data 206 designated with the command based on a desired test of a performance characteristic. If, for example, it is desirable to test the compression rate of data stored on the second device 204, dummy data 206 of varying compressibility may be designated. An alternative example may include a verification of accuracy. In this example, the designation module 412 may designate a dummy data set 206 with a known pseudo-random pattern.

The measurement module 414 gathers data on the performance of the second device 204. The measurement module 414 may gather data on either the commands issued to the second device 204, or the response to the commands from the second device 204. The data gathered by the measurement 414 module may characterize the data transmission rate, the data throughput, the predictability of the responses from the second device 204, and the like.

The analysis module 416 analyzes the data gathered by the measurement 414 module. The analysis module 416 may include identification of specific performance trends. Alternatively, the analysis module 416 may simply comprise a summary of the communications between the simulator 202 and the second device 204. In one embodiment, the analysis module 416 generates charts or other performance related reports that summarize the analysis.

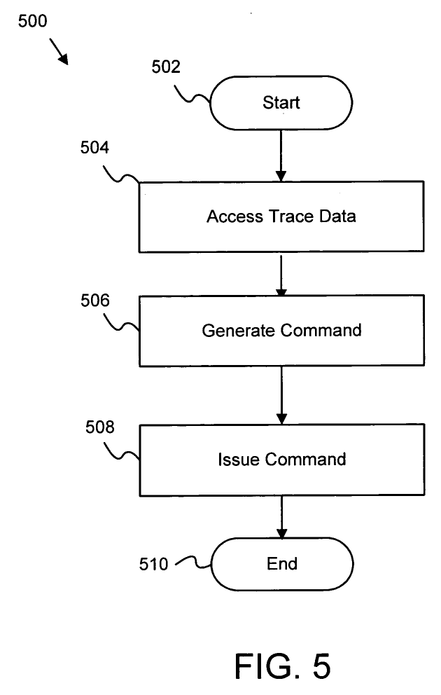

FIG. 5 illustrates a schematic flow chart diagram of a method 500 for simulating communication between a plurality of devices. The method 500 begins 502 when a data communications link has been established between the simulator 202 and the second device 204, and trace data 210 is available. The reader module 304 accesses 504 the trace data 210, and the generator module 306 generates 506 commands from the trace data 210. The generator module 306 may generate the command responsive to receiving a line of trace data 210 read by the reader module 304. The controller module 308 then issues 508 the command to the second device 204. If the trace data 210 includes more lines, the reader module 304 accesses 504 a next line and the steps 504-508 are repeated until all the trace data lines are sent to the second device 204 at which point the method 500 ends 510. The controller 308 module may issue 508 the command via a data SCSI data connection. Alternatively, the controller 308 module may issue 508 the command via fiber channel, wireless, Ethernet, or some other data communications link. These data communications links are used because the actual hardware of the second device 204 is being tested.

In one embodiment, the reader module 304 reads 504 the trace data 210 line by line. Alternatively, the reader module 304 may read 504 the entire trace data file 210 at once and the generator module 306 may process the trace data 210 line by line. The commands are generated 506 from the trace data 210 in a manner that simulates an original command communicated between the devices. The type and frequency of the commands are preferably determined from the trace data 210 as well.

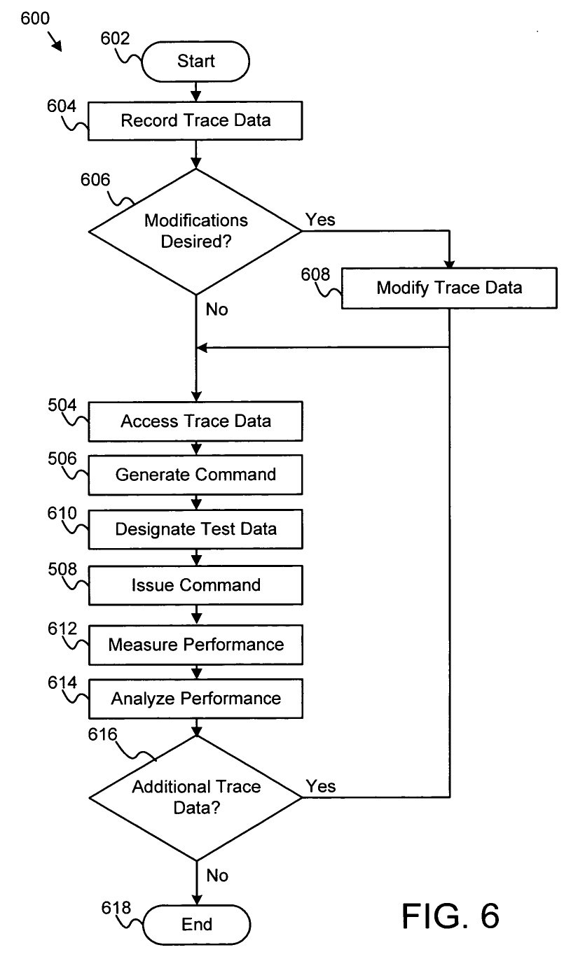

FIG. 6 illustrates a schematic flow chart diagram of a detailed embodiment of a method 600 for simulating communications between a plurality of devices. The method 600 begins 602 when the need for simulation of communications between a plurality of devices exists. Trace data 110 is recorded 604 using a recorder 108 in a system 100 configured to record communications between a plurality of devices. Typically, a user then determines 606 if modifications to the trace data 110 are desireable. If modifications are desired 606, then the trace data 210 is modified 608 to change the order and type of commands generated in order to test performance of a second device 204. If the modifications 608 have been made or if no modifications are desired 606, then the trace data 210 is accessed by the reader module 304. Once the trace data 210 has been accessed, the generator module 306 generates a command that simulates an original command from a segment of the trace data 210. The designation module 412 may designate 610 dummy data 206 for the command. Certain commands may not require dummy data 206. The command is then issued to the second device 204. If additional trace data exists 616, the process repeats from the point of the reader module 304 accessing the trace data. If no additional trace data exists 616, the method ends 618.

In the method 600, the modification module 410 may modify 608 the trace data 210 to test certain performance characteristics of the second device 204. These performance characteristics may include data transmission rate, data compressibility, data accuracy, and reliability of successful data transmission. The modifications may include changes to the command types, the time between commands, the size of data blocks, and the number of commands. It may be determined 606 that modifications to the trace data 210 are desired, based on the need to test performance characteristics of the second device 204. Additionally, the dummy data 206 format may be varied to further test the performance characteristics of the second device 204. The designation 412 module may designate 610 variable formats of dummy data 206 to further test the performance of the second device 204.

The measurement module 414 and the analysis module 416 measure 612 and analyze 614 the performance of the second device 204. These measurements 414 and corresponding analysis may be performed responsive to modifications 608 made to the trace data. These modules allow for more detailed characterization of the communications between the simulator 202 and the second device 204.

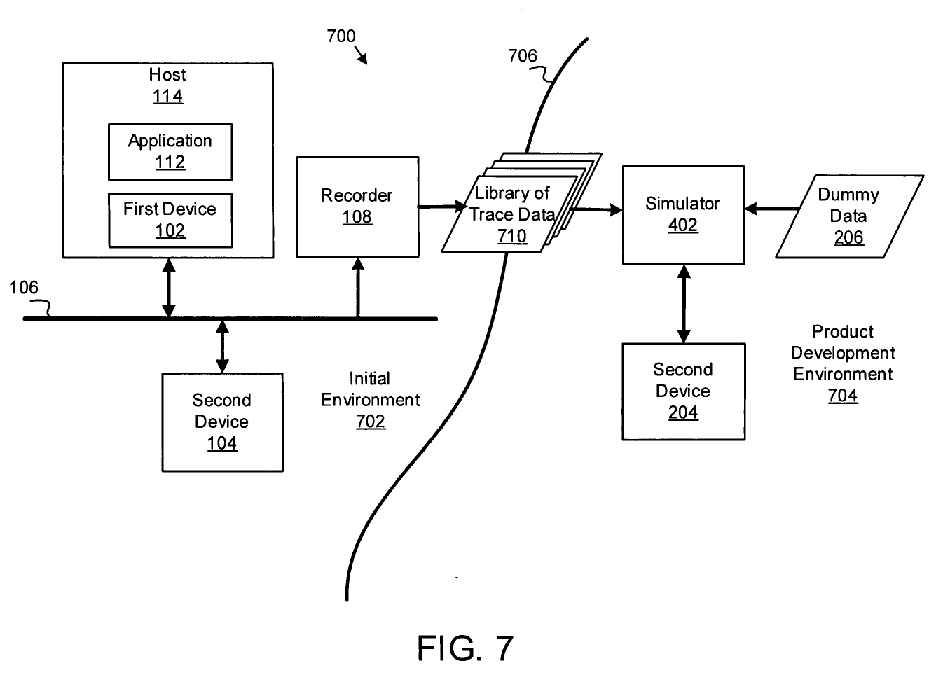

FIG. 7 illustrates one embodiment of the relationship 700 between an initial environment 702 and a product development environment 704, incorporating components required for simulating communications between a plurality of devices. In this example, the initial environment 702 essentially includes all of the components of the system 100. The initial environment 702 is typically a test environment that allows for trace data 110 to be recorded for actual communications with a second device 204. Alternatively, the initial environment 702 may comprise an actual environment at an end-user's site configured to use the second device 204 or substantially similar devices. The trace data 110 may be recorded and inserted in a library of trace data 710 containing a plurality of files containing prerecorded trace data 110. In this manner, various kinds of trace data 110 may be used to test performance of a second device 204.

Once the trace data 110 is collected, a product development environment 704 may be used to develop and refine the second device 204 and/or other similarly configured second devices 204. Line 706 represents a transition from an initial environment 702 to a product development environment 704.

In this embodiment, the product development environment 704 includes essentially all of the components of the system 200 for simulating communications between a plurality of devices. In one embodiment, the simulator 402 includes all of the modules as described in the detailed embodiment of the apparatus 400 (See FIG. 4) for simulating communications between a plurality of devices.

The second environment 704 may also be used for product testing, product maintenance, and/or product troubleshooting. In these various embodiments, the initial environment 702 may differ widely. In the case of product troubleshooting, the initial environment 702 may be a system already fielded to a customer. The environment 702 may include the typical components 102, 112, and 114 at the customer's site that communicate with the second device 104. A series of tests may be performed and trace data 110 recorded. The trace data 110 may be sent to the product manufacturer along with the customer's second device 204 such as a tape storage device. The trace data 110 and second device 204 may be placed in the troubleshooting environment 704. The troubleshooting environment 704 would include the components of the product development environment 704. In this instance, a manufacturer is able to recreate the problematic environment using the communications simulator 402 without having to acquire and configure all of the equipment in the initial environment 702.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for simulating communications between a plurality of devices, the apparatus comprising:
a reader module configured to access trace data representative of communications between a first device and a second device;
a generator module configured to generate a command from the trace data to simulate an original communication; and
a controller module configured to issue the command to the second device.

2. The apparatus of claim 1, further comprising a modification module configured to modify the trace data to change the order and type of commands generated in order to test performance of the second device.

3. The apparatus of claim 1, further comprising a measurement module configured to measure performance of the second device in response to the command.

4. The apparatus of claim 1, further comprising a designation module configured to designate a dummy data set for the command.

5. The apparatus of claim 4, wherein the trace data and dummy data are selected to facilitate product activities for the second device selected from the group consisting of product development, product testing, and product troubleshooting.

6. The apparatus of claim 1, wherein the trace data comprises prerecorded communications between a first device and a second device.

7. The apparatus of claim 1, further comprising an analysis module configured to analyze a performance impact of modifications made to the trace data.

8. The apparatus of claim 1, wherein the trace data and dummy data are selected from a library of trace data and one or more dummy data sets.

9. The apparatus of claim 8, wherein the trace data is selected according to at least one performance characteristic of the second device.

10. An apparatus for simulating communications between a plurality of devices, the apparatus comprising:
a reader module configured to access the trace data representative of communications between a first device and a second device;
a generator module configured to recreate a command from a line of the trace data to simulate an original communication command; and
a controller module configured to issue the command to a receive port of the device.

11. The apparatus of claim 10, further comprising a modification module configured to modify the trace data to change the order and type of commands generated in order to test performance of the device.

12. The apparatus of claim 10, further comprising a measurement module configured to measure performance of the device in response to the command.

13. The apparatus of claim 10, further comprising a designation module configured to designate a dummy data set for the command.

14. The apparatus of claim 13, wherein the trace data and dummy data are selected to facilitate product activities for the second device selected from the group consisting of product development, product testing, and product troubleshooting.

15. The apparatus of claim 10, wherein the trace data comprises prerecorded communications between a first device and a second device.

16. The apparatus of claim 10, further comprises an analysis module configured to analyze the performance impact of modifications made to the trace data.

17. The apparatus of claim 10, wherein the trace data and dummy data are selected from a library of trace data and one or more dummy data sets.

18. The apparatus of claim 17, wherein the trace data is selected according to at least one performance characteristic of the device.

19. A system for simulating communications between a plurality of devices, the system comprising:
a recorder module configured to record communications between a first device and a second device;
a library of trace data sets representative of communications between one or more first devices and a second device;
a simulator module configured to simulate communications with the second device, the simulator module comprising:
a reader module configured to access a trace data set from the library;
a generator module configured to generate a command from the trace data set, the command simulating an original communication;
a controller module configured to issue the command to the second device; and
wherein the second device is in communication with the simulator and configured to receive and respond to the command.

20. The system of claim 19, further comprising a modification module configured to modify the trace data to change the order and type of commands generated in order to test performance of the second device.

21. The system of claim 20, further comprising a listener module configured to listen for responses from the second device to commands issued by the simulator module.

22. The system of claim 21, further comprising a measurement module configured to measure performance of the second device in response to the command.

23. The system of claim 22, further comprising a designation module configured to designate a dummy data set for the command.

24. The system of claim 23, further comprising an analysis module configured to analyze the performance impact of modifications made to the trace data.

25. The system of claim 24, wherein the trace data comprises prerecorded communications between a first device and a second device.

26. The system of claim 25, wherein the trace data and dummy data are selected from a library of trace data and one or more dummy data sets.

27. The system of claim 26, wherein the trace data is selected according to at least one performance characteristic of the second device.

28. A signal bearing medium tangibly embodying a program of machine-readable instructions executable by a digital processing apparatus to perform operations to simulate communications between a plurality of devices, the operations comprising:
an operation to access trace data representative of communications between a first device and a second device;
an operation to generate a command from the trace data to simulate an original communication; and
an operation to issue the command to the second device.

29. The signal bearing medium of claim 28, wherein the operations further comprise an operation to modify the trace data to change the order and type of commands generated in order to test performance of the second device.

30. The signal bearing medium of claim 28, wherein the operations further comprise an operation to measure performance of the second device in response to the command.

31. The signal bearing medium of claim 28, wherein the operations further comprise an operation to designate a dummy data set for the command.

32. The signal bearing medium of claim 31, wherein the trace data and dummy data are selected to facilitate product activities for the second device selected from the group consisting of product development, product testing, and product troubleshooting.

33. The signal bearing medium of claim 28, wherein the trace data comprises prerecorded communications between a first device and a second device.

34. The signal bearing medium of claim 28, wherein the operations further comprise an operation to analyze the performance impact of modifications made to the trace data.

35. The signal bearing medium of claim 28, wherein the trace data and dummy data are selected from a library of trace data and one or more dummy data sets.

36. The signal bearing medium of claim 35, wherein the trace data is selected according to at least one performance characteristic of the second device.

37. A method for simulating communications between a plurality of devices, the method comprising:
accessing trace data representative of communications between a first device and a second device;
generating a command from the trace data to simulate an original communication; and
issuing the command to the second device.

38. The method of claim 37, wherein the method further comprises modifying the trace data to change the order and type of commands generated in order to test performance of the second device.

39. The method of claim 37, wherein the method further comprises measuring the performance of the second device in response to the command.

40. An apparatus for simulating communications between a plurality of devices, the apparatus comprising:
means for accessing trace data representative of communications between a first device and a second device;
means for generating a command from the trace data to simulate an original communication; and
means for issuing the command to the second device.
